(19) United States
(12) Patent Application Publication
(10) Pub. No.: US 2010/0183315 A1
(43) Pub. Date: Jul. 22, 2010

(54) POWER SUPPLY MODULE OF OPTICAL NETWORK TERMINAL SYSTEM

(75) Inventor: Yung-Hung Yang, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/624,897

(22) Filed: Nov. 24, 2009

(30) Foreign Application Priority Data
Jan. 22, 2009 (TW) 098102535

(51) Int. Cl. H04B 10/00; H02J 9/00

(52) U.S. Cl. 398/135; 307/66

(57) ABSTRACT

A power supply module includes a backup battery unit and a power supply unit. The backup battery unit has at least one first engaging element. The power supply unit has at least one second engaging element mating with the first engaging element. After the second engaging element is engaged with the first engaging element, the power supply unit is detachably connected with the backup battery unit.

### FIELD OF THE INVENTION

The present invention relates to a power supply module, and more particularly to a power supply module of an optical network terminal system.

### BACKGROUND OF THE INVENTION

With rapid development of communication technologies, the speed of transmitting data is gradually increased. In recent years, optical fibers are widely used in fiber-optic communications. Optical fibers may permit transmission over longer distances and at higher data rates than copper wires because light propagates through the optical fibers with little attenuation compared to copper wires. Gradually, conventional copper wires are replaced with optical fibers. Generally, the fiber-optic communication is immune to electromagnetic interference and very safe, and has less transmission loss and high transmission rate. In addition, the optical fibers have light weightiness and low volume. As a consequence, the optical fibers are suitable for long-distance or short-distance signal communication. Recently, optical fibers provide the backbones for many network systems including telecommunication systems, broadband network systems and cable television services. A so-called fiber-optic communication system integrates the functions of many network systems to transmit information from one place to another so as to provide convenient and quick services.

For mounting the fiber-optic communication system in the client side, the client-side unit has an optical network terminal system. Conventionally, the client-side optical network terminal system principally comprises an optical network terminal (ONT) device, a broadband home router (BHR), a backup battery unit (BBU) and an optical network terminal power supply unit (OPSU). The optical network terminal device is used for receiving and transmitting signals or further processing the signals. The optical network terminal device is connected to external optical fibers and the broadband home router. After the network transmission signals are checked by the broadband home router, the network transmission signals are transmitted to designated positions at the client side along the paths set by the broadband home router. The power supply unit is used to convert the utility AC voltage into a regulated DC voltage and deliver the regulated DC voltage to the backup battery unit. The regulated DC voltage is transmitted from the backup battery unit to the optical network terminal device to provide electricity required for powering the optical network terminal device. The residual electricity is stored in the battery pack of the backup battery unit. In a case that the utility AC voltage is suffered from a sudden variation or interruption, the backup battery unit can provide the residual electricity to the optical network terminal device.

Since the optical network terminal device, the backup battery unit and the power supply unit of the conventional optical network terminal system are bulky, the space for constructing the optical network terminal system is very large. In addition, the power supply unit is usually fixed on a wall that is close to the optical network terminal device. If the space for constructing the optical network terminal system is insufficient or the distance between the electrical socket and the power supply unit is too short, the locations of the power supply unit and the backup battery unit are restricted. Under this circumstance, it is troublesome to construct the optical network terminal system.

There is a need of providing an improved power supply module of an optical network terminal system so as to obviate the drawbacks encountered from the prior art.

### SUMMARY OF THE INVENTION

It is an object of the present invention to provide a power supply module of an optical network terminal system, in which the locations of the power supply unit and the backup battery unit are adjustable according to the practical requirements.

In accordance with an aspect of the present invention, there is provided a power supply module of an optical network terminal system. The power supply module includes a backup battery unit and a power supply unit. The backup battery unit has at least one first engaging element. The power supply unit has at least one second engaging element mating with the first engaging element. After the second engaging element is engaged with the first engaging element, the power supply unit is detachably connected with the backup battery unit.

In accordance with another aspect of the present invention, there is provided an optical network terminal system. The optical network terminal system includes an optical network terminal device and a power supply module. The optical network terminal device receives and processes an optical fiber transmission signal. The power supply module is used for proving a regulated DC voltage required for powering the optical network terminal device. The power supply module includes a backup battery unit and a power supply unit. The backup battery unit has at least one first engaging element. The power supply unit has at least one second engaging element mating with the first engaging element. After the second engaging element is engaged with the first engaging element, the power supply unit is detachably connected with the backup battery unit.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a client-side optical network terminal system according to an embodiment of the present invention;

FIG. 2 is a schematic view illustrating a first exemplary power supply module of the present invention;

FIG. 3A is a schematic cross-sectional view illustrating the connection between the first engaging element and the second engaging element of the power supply module shown in FIG. 2;

FIG. 3B is a schematic cross-sectional view illustrating the first positioning element and the second positioning element of the power supply module shown in FIG. 2, which have not yet been sustained against each other;

FIG. 3C is a schematic cross-sectional view illustrating the first positioning element and the second positioning element of the power supply module shown in FIG. 2, which are sustained against each other;

FIG. 4 is a schematic assembled view of the power supply module of FIG. 2;

FIG. 5 is a schematic view partially illustrating the backside of the power supply module of FIG. 4; and

FIG. 6 is a schematic view illustrating a second exemplary power supply module of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

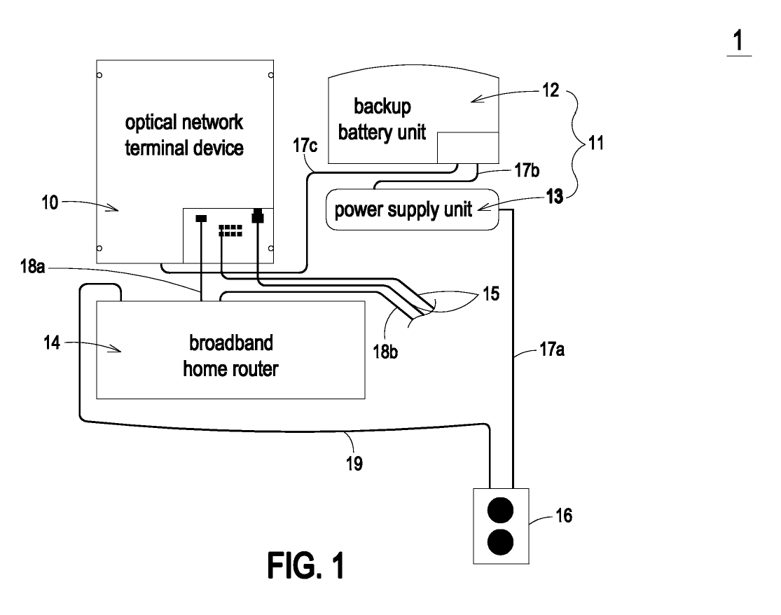

FIG. 1 is a schematic functional block diagram illustrating a client-side optical network terminal system according to an embodiment of the present invention. As shown in FIG. 1, the client-side optical network terminal system 1 principally comprises an optical network terminal device 10 and a power supply module 11. The optical network terminal device 10 is connected to the system-side optical fibers 15 for receiving and transmitting signals. Alternatively, the optical network terminal device 10 may further process the signals. The power supply module 11 includes a backup battery unit (BBU) 12 and a power supply unit 13. The power supply unit 13 is electrically connected to an electrical socket 16 through a cable 17a. As such, the utility AC voltage is delivered to the power supply unit 13 through the cable 17a and then converted into a regulated DC voltage by the power supply unit 13. The regulated DC voltage is transmitted from the power supply unit 13 to the backup battery unit 12 through another cable 17b. The regulated DC voltage is transmitted from the backup battery unit 12 to the optical network terminal device 10 through a cable 17c so as to provide electricity required for powering the optical network terminal device 10. The residual electricity is stored in the battery pack (not shown) of the backup battery unit 12. In a case that the utility AC voltage is suffered from a sudden variation or interruption, the backup battery unit 12 can provide the residual electricity to the optical network terminal device 10.

Moreover, the optical network terminal system 1 further includes a broadband home router (BHR) 14. The broadband home router 14 is connected with the optical network terminal device 10 through the cable 18a. The broadband home router 14 is also connected with the electrical socket 16 through the cable 19 such that the utility AC voltage from the electrical socket 16 may power the broadband home router 14. After the signals from the optical network terminal device 10 are received by the broadband home router 14, the broadband home router 14 will check the safety of the signals and reset the transmission paths of the signals. The processed signals are then transmitted to designated positions at the client side via the cable 18b. Examples of the signals include but are not limited to broadband network connection signals, cable television signals or telecommunication signals.

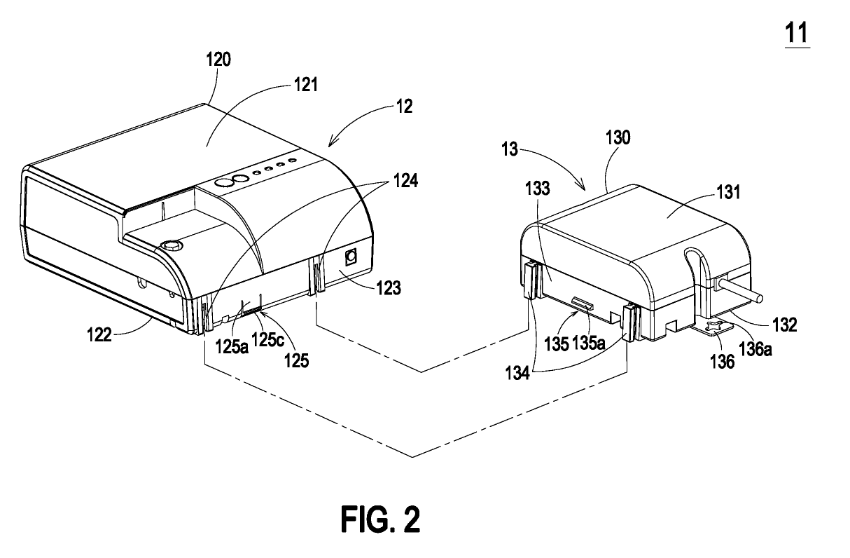

FIG. 2 is a schematic view illustrating a first exemplary power supply module of the present invention. As shown in FIG. 2, the power supply module 11 includes a backup battery unit (BBU) 12 and a power supply unit 13. The backup battery unit 12 has a case 120. A receptacle (not shown) is defined within the case 120 for accommodating a circuit board (not shown) and at least one battery (not shown). The case 120 has an upper surface 121, a lower surface 122 and a first surface 123. The upper surface 121 and the lower surface 122 are opposed to each other. The first surface 123 is connected to the upper surface 121 and the lower surface 122. At least one first engaging element 124 and a first positioning element 125 are formed on the first surface 123. In this embodiment, the first engaging element 124 is a gliding rail and the first positioning element 125 includes a slab 125a and a first bulge 125c.

Please refer to FIG. 2 again. The power supply unit 13 has a case 130. Similarly, a receptacle (not shown) is defined within the case 130 for accommodating a circuit board (not shown). The case 130 has an upper surface 131, a lower surface 132 and a second surface 133. The upper surface 131 and the lower surface 132 are opposed to each other. The second surface 133 is connected to the upper surface 131 and the lower surface 132. At least one second engaging element 134 and a second positioning element 135 are formed on the second surface 133. The location of the second engaging element 134 corresponds to the location of the first engaging element 124 on the first surface 123 of the backup battery unit 12. The location of the second positioning element 135 corresponds to the location of the first positioning element 125 of the backup battery unit 12. In this embodiment, the first engaging element 124 is gliding rail and the second engaging element 134 is a raised block. The second engaging element 134 of the power supply unit 13 and the first engaging element 124 of the backup battery unit 12 have complementary shapes such that the second engaging element 134 and the first engaging element 124 may be engaged with each other. The second positioning element 135 includes a second bulge 135a. When the second engaging element 134 and the first engaging element 124 are engaged with each other, the power supply unit 13 and the backup battery unit 12 are combined together. At the same time, the second bulge 135a of the second positioning element 135 is sustained against the first bulge 125c of the first positioning element 125 of the backup battery unit 12 so as to facilitate positioning the power supply unit 13 on the backup battery unit 12. In addition, the power supply unit 13 has a connecting part 136. An example of the connecting part 136 is a protrusion plate having a perforation 136a. A fastening element (e.g. a screw) may penetrate through the perforation 136a for securing the power supply unit 13 to a support member (not shown) or a wall.

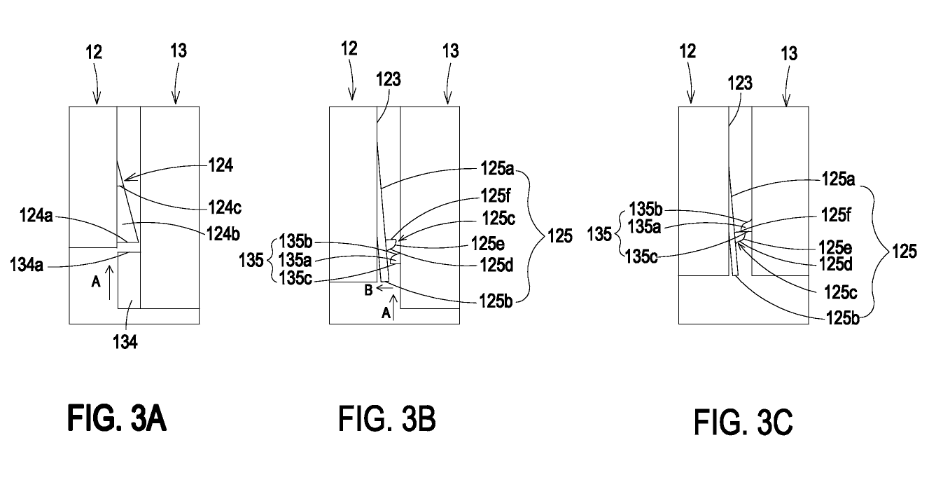

FIG. 3A is a schematic cross-sectional view illustrating the connection between the first engaging element and the second engaging element of the power supply module shown in FIG. 2. Please refer to FIG. 2 and FIG. 3A. For coupling the power supply unit 13 with the backup battery unit 12, the second engaging element (for example raised block) 134 of the power supply unit 13 is moved along the first engaging element (for example gliding rail) 124 of the backup battery unit 12 in the direction A. That is, the power supply unit 13 is moved on the backup battery unit 12 from bottom to top. As such, the second engaging element 134 of the power supply unit 13 enters the receiving part 124b of the first engaging element 124 through the entrance 124a. Until the upper side 134a of the second engaging element 134 is sustained against the inner surface 124c of the first engaging element 124, the movement of the second engaging element 134 is restricted by the first engaging element 124. Meanwhile, the second engaging element 134 is engaged with the first engaging element 124, so that the power supply unit 13 and the backup battery unit 12 are combined together.

FIG. 3B is a schematic cross-sectional view illustrating the first positioning element and the second positioning element of the power supply module shown in FIG. 2, which have not yet been sustained against each other. FIG. 3C is a schematic cross-sectional view illustrating the first positioning element and the second positioning element of the power supply module shown in FIG. 2, which are sustained against each other. Please refer to FIG. 2, FIG. 3B and FIG. 3C. The first positioning element 125 includes a slab 125a, a free end 125b and the first bulge 125c. Due to the free end 125b, the slab 125a is slightly elastic. When the second positioning element 135 of the power supply unit 13 is moved along the first positioning element 125 of the backup battery unit 12 in the direction A, the second bulge 135a of the second positioning element 135 is firstly contacted with the free end 125b of the first positioning element 125 and then moved on the slant surface of the slab 125a. Once the upper side 135b of the second bulge 135a is sustained against the lower side 125d of the first bulge 125c, the second bulge 135a exerts a force on the slab 125a such that the slab 125a is moved toward the first surface 123 of the backup battery unit 12 in the direction B. As the second positioning element 135 of the power supply unit 13 is continuously moved in the direction A, the second bulge 135a is moved across the tip part 125e of the first bulge 125c. As such, the force exerted by the second bulge 135a is eliminated and the slab 125a is returned to its original position. Meanwhile, the upper side 125f of the first bulge 125c is sustained against the lower side 135c of the second bulge 135a, so that the first positioning element 125 and the second positioning element 135 are engaged with each other to facilitate positioning the power supply unit 13 on the backup battery unit 12 (as is shown in FIG. 3C).

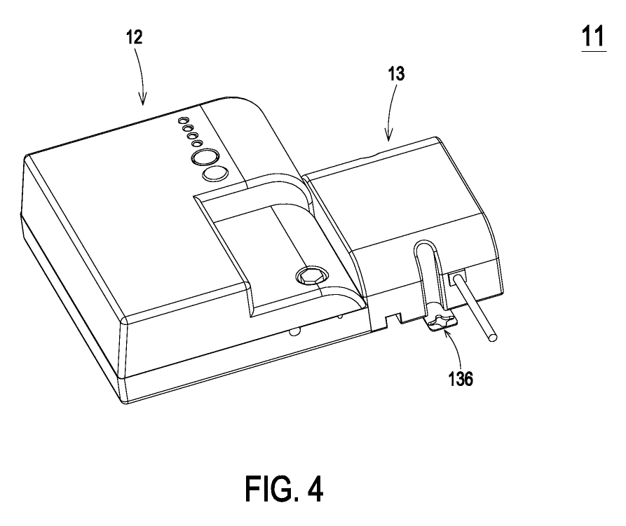

FIG. 4 is a schematic assembled view of the power supply module of FIG. 2. Please refer to FIGS. 2, 3 and 4. After the second engaging element 134 and the first engaging element 124 are engaged with each other and the first positioning element 125 and the second positioning element 135 are engaged with each other, the power supply unit 13 is fixed on the backup battery unit 12, as is shown in FIG. 4. In accordance with a key feature of the present invention, the power supply unit 13 is detachable from the backup battery unit 12. When the power supply unit 13 is moved in a direction reverse to the direction A, the power supply unit 13 can be smoothly detached from the backup battery unit 12. In accordance with another key feature of the present invention, a fastening element (e.g. a screw) may penetrate through the perforation 136a of the connecting part 136 for securing the power supply unit 13 to a support member (not shown) or a wall that is disposed adjacent to the electrical socket 16 (as shown in FIG. 1). In other words, since the power supply unit 13 is detachably connected with the backup battery unit 12, the power supply unit 13 may be disposed in the location adjacent to the electrical socket 16. As a consequence, the flexibility of constructing the power supply module 11 of the present invention is enhanced.

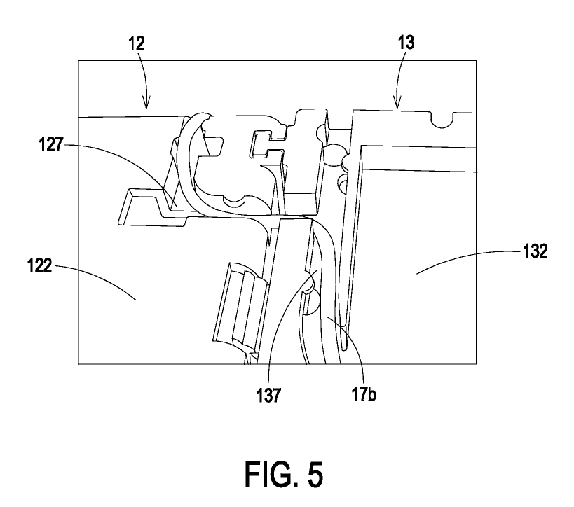

FIG. 5 is a schematic view partially illustrating the backside of the power supply module of FIG. 4. As shown in FIG. 5, after the power supply unit 13 and the backup battery unit 12 are combined together, the cable 17b for connecting the power supply unit 13 with the backup battery unit 12 may be accommodated within the receptacle 137 in the lower surface 132 of the power supply unit 13 and the receptacle 127 in the lower surface 122 of the backup battery unit 12. Since the cable 17b is stored in the receptacles 127 and 137, the possibility of causing a messy and disorganized cable arrangement of the cable 17b is minimized. It is noted that, however, those skilled in the art will readily observe that numerous modifications may be made while retaining the teachings of the invention. For example, the receptacles 127 and 137 may be respectively disposed within the backup battery unit 12 and the power supply unit 13.

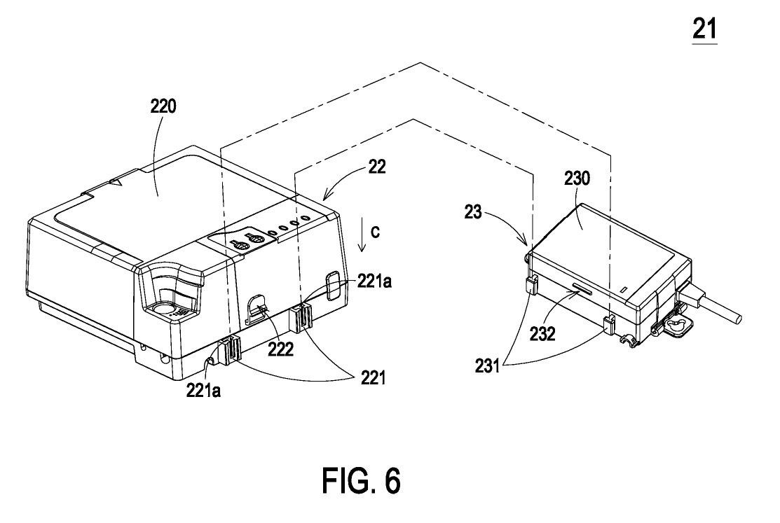

FIG. 6 is a schematic view illustrating a second exemplary power supply module of the present invention. As shown in FIG. 6, the power supply module 21 includes a backup battery unit 22 and a power supply unit 23. The backup battery unit 22 includes a case 220, a first engaging element 221 and a first positioning element 222. The power supply unit 23 includes a case 230, a second engaging element 231 mating with the first engaging element 221, and a second positioning element 232 mating with the first positioning element 222. The case 220, the first engaging element 221 and the first positioning element 222 of the backup battery unit 22, and the case 230, the second engaging element 231 and the second positioning element 232 of the power supply unit 23 have structures similar to those shown in the first exemplary power supply module 11, and are not redundantly described herein. As shown in FIG. 2, the entrance 124a of the first engaging element 124 faces toward the bottom side. On the contrary, the entrance 221a of the first engaging element 221 (e.g. a gliding rail) in this embodiment faces toward the top side. For coupling the power supply unit 23 with the backup battery unit 212, the power supply unit 23 is moved along the of the backup battery unit 22 in the direction C. That is, the power supply unit 23 is moved on the backup battery unit 22 from top to bottom. After the first engaging element 221 and the second engaging element 231 are engaged with each other and the first positioning element 222 and the second positioning element 223 are engaged with each other, the power supply unit 23 and the backup battery unit 22 are combined together.

From the above description, the power supply module of the present invention includes a backup battery unit and a power supply unit, wherein the backup battery unit has a first engaging element and a first positioning element, and the power supply unit has a second engaging element and a second positioning element. After the first engaging element and the second engaging element are engaged with each other and the first positioning element and the second positioning element are engaged with each other, the power supply unit is detachably connected with the backup battery unit. According to the practical constructing space and the distance from the electrical socket, the location of the power supply unit is adjustable as required. As a consequence, the flexibility of constructing the power supply module of the optical network terminal system is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply module of an optical network terminal system, said power supply module comprising:
a backup battery unit having at least one first engaging element; and
a power supply unit having at least one second engaging element mating with said first engaging element, wherein after said second engaging element is engaged with said first engaging element, said power supply unit is detachably connected with said backup battery unit.

2. The power supply module according to claim 1 wherein said first engaging element is disposed on a first surface of said backup battery unit.

3. The power supply module according to claim 1 wherein said second engaging element is disposed on a second surface of said power supply unit.

4. The power supply module according to claim 1 wherein said first engaging element is a gliding rail.

5. The power supply module according to claim 4 wherein said second engaging element is a raised block, which is movably along said gliding rail.

6. The power supply module according to claim 1 wherein said backup battery unit further includes a first positioning element on a first surface of said backup battery unit.

7. The power supply module according to claim 6 wherein said power supply unit further includes a second positioning element on a second surface of said power supply unit.

8. The power supply module according to claim 7 wherein said first positioning element includes a slab and a first bulge, said second positioning element includes a second bulge, and a lower side of said second bulge is sustained against an upper side of said first bulge so as to facilitate positioning said power supply unit on said backup battery unit.

9. The power supply module according to claim 1 wherein a receptacle is formed in a lower surface of said backup battery unit for accommodating a cable that connects said backup battery unit with said power supply unit.

10. The power supply module according to claim 1 wherein said power supply unit further includes a connecting part having a perforation, and a fastening element penetrates through said perforation for securing said power supply unit to a support member or a wall.

11. An optical network terminal system comprising:
an optical network terminal device for receiving and processing an optical fiber transmission signal; and
a power supply module for proving a regulated DC voltage required for powering said optical network terminal device, said power supply module comprising:
a backup battery unit having at least one first engaging element; and
a power supply unit having at least one second engaging element mating with said first engaging element, wherein after said second engaging element is engaged with said first engaging element, said power supply unit is detachably connected with said backup battery unit.

12. The optical network terminal system according to claim 11 wherein said first engaging element is a gliding rail, which is disposed on a first surface of said backup battery unit.

13. The optical network terminal system according to claim 12 wherein said second engaging element is a raised block, which is disposed on a second surface of said power supply unit and movably along said gliding rail.

14. The optical network terminal system according to claim 11 wherein said backup battery unit further includes a first positioning element on a first surface of said backup battery unit.

15. The optical network terminal system according to claim 14 wherein said power supply unit further includes a second positioning element on a second surface of said power supply unit to be engaged with said first positioning element of said backup battery unit.

16. The optical network terminal system according to claim 15 wherein said first positioning element includes a slab and a first bulge, said second positioning element includes a second bulge, and a lower side of said second bulge is sustained against an upper side of said first bulge so as to facilitate positioning said power supply unit on said backup battery unit.

17. The optical network terminal system according to claim 11 wherein a receptacle is formed in a lower surface of said backup battery unit for accommodating a cable that connects said backup battery unit with said power supply unit.

18. The optical network terminal system according to claim 11 wherein said power supply unit further includes a connecting part having a perforation, and a fastening element penetrates through said perforation for securing said power supply unit to a support member or a wall.
